(19) United States
(12) Patent Application Publication
(10) Pub. No.: US 2012/0245024 A1
(43) Pub. Date: Sep. 27, 2012

(54) METHOD FOR MANUFACTURING A CATALYST SUPPORT

(75) Inventors: Christophe CHAPUT, Le Palais sur Vienne (FR); Richard GAIGNON, Saint Vrain (FR); Pascal DEL GALLO, Dourdan (FR)

(73) Assignee: 3DCERAM, LIMOGES (FR)

(21) Appl. No.: 13/428,081

(22) Filed: Mar. 23, 2012

(30) Foreign Application Priority Data
Mar. 25, 2011 (FR) 1152523

(51) Int. Cl. B01J 37/08; B01J 21/04; B01J 23/46; B01J 27/18; B01J 23/42; B01J 23/44; B01J 21/10; B01J 21/06

(52) U.S. Cl. 502/339; 502/439; 502/100; 502/325

(57) ABSTRACT

A method for manufacturing a catalyst support, includes, in the following order, the steps of: (a) shaping a non-sintered porous ceramic base support; (b) depositing, on at least part of the surface of the non-sintered porous ceramic base support, a suspension of ceramic powder in a solvent or a mixture of solvents so as to form an interface layer able to increase the surface area of the base support; (c) sintering the base support, at least partially coated with the suspension. This method allows to economically and rapidly manufacture catalyst supports, and especially burners for fragrance diffuser.

### CROSS REFERENCE TO RELATED APPLICATIONS

Applicant claims priority under 35 U.S.C. 119 of French patent application no. 1152523 filed on 25 Mar. 2011.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The invention generally relates to the field of porous ceramic catalyst supports, especially catalytic combustion supports.

Porous ceramics are used as catalyst supports in many applications. They are useful especially in the catalytic converters of motor vehicles. These generally contain a honeycomb ceramic support, on which a catalyst is deposited, often platinum-based. These supports allow catalyzing the reduction of pollutants such as carbon monoxyde and nitrogen oxides present in the exhaust gases that pass through the support.

Porous ceramics are also used for the manufacture of burners, e.g. burners for fragrance diffuser. Such devices are specifically described in French patent applications FR2779509, FR2856775 or FR2856776. Most of the time, they consist of a flask containing a solvent, e.g. an alcool, optionally mixed with odoriferous and/or deodorant substances. A porous ceramic burner is arranged on the neck of the flask. The shape of this burner may vary depending on the devices. As an example, the burner may consist of a porous ceramic part in the shape of a truncated cone. The upper part of the burner includes a central area and an annular peripheral area, which is the actual combustion area. The peripheral area is coated with a thin catalyst layer. The composition of this catalyst may vary, but it is often platinum-based. The flask also contains a woven or porous wick which is fixed to the burner at one of its ends. For example, the wick is inserted in a cavity of the burner, present in the lower part thereof, and open in the direction of the flask. At its other end, the wick dips in the solvent. In that manner, the solvent diffuses by capillarity along the wick and comes impregnating the burner. To initiate the combustion, a flame is ignited above the burner, thereby igniting the solvent vapors and the impregnated solvent in the burner. This flame is allowed to burn for a few minutes, so as to increase the temperature of the burner, and then the flame is extinguished. The combustion continues in the peripheral area of the burner in the form of a catalytic combustion.

Catalytic combustion burners are traditionally manufactured according to the following method: starting by shaping a porous ceramic base support or “greenware”, then sintering this base support, i.e. submitting it to a thermal processing so as to bond the ceramic grains together to impart a mechanical resistance to the support. Then, the catalytic composition is deposited on a part of the sintered support, e.g. on the peripheral area in case of a fragrance diffuser burner.

This technique comprises the drawback of resulting in a poor dispersion of the catalyst, which forms aggregates at the surface of the burner. However, the combustion reaction can only occur if the catalyst is in the form of very fine particules, in the range of a few nanometers, and perfectly dispersed on the surface of the support. The combustion reaction also requires these particules to be in a sufficient number. Indeed, each of these fine catalyst particules constitutes an active site and the number of active sites has to be sufficient to ensure the catalytic combustion, so that it produces enough heat to maintain the reaction and this with no alteration of the performances over the time.

Another method is traditionally used for manufacturing catalytic converters in the field of honeycomb supports for catalytic converters. This method comprises manufacturing a sintered porous ceramic support, then depositing, on the sintered support, an interface layer which is then submitted to a thermal processing. The interface layer consists of a high surface area material which allows improving the dispersion of the catalyst at the surface of the support. Thus, the number of available active sites is increased, thereby resulting in a better catalytic combustion. As described above, this method requires two thermal processing steps: high temperature sintering of the porous ceramic support, and firing of the interface layer.

These two thermal processing steps result in high manufacturing costs and times which are strongly detrimental, even prohibitive for manufacturing supports at a reasonable cost. This is particularly true regarding the manufacture of parts that have a relatively low selling price, such as the burners for fragrance diffuser.

### BRIEF SUMMARY OF THE INVENTION

Therefore, the aim of the present invention is to provide a method for manufacturing a catalyst support, characterised in that it comprises, in the following order, the steps of:

(a) shaping a non-sintered porous ceramic base support;
(b) depositing, on at least part of the surface of the non-sintered porous ceramic base support, a suspension of ceramic powder in a solvent or a mixture of solvents to form an interface layer able to increase the surface area of the base support;
(c) sintering the base support, at least partially coated with the suspension.

The method of the present invention comprises only one firing step, during which both sintering of the porous ceramic base support and thermal processing of the suspension deposited at the surface of the base support are carried out. This results in a significant reduction in terms of manufacturing costs and manufacturing time of the catalyst support.

The deposition, at the surface of the base support, of a suspension of ceramic powder in one or more solvents aims to form an interface layer coating the whole or part of the base support. The features (cristalline phase, microstructure) of this interface layer are achieved during thermal processing, at step (c) of the suspension deposited at the surface of the base support. The interface layer allows to increase the surface area of the base support, and, thereby improves the dispersion of the catalyst.

The manufacture of the porous ceramic base support can be carried out by any means known in the art. The manufacture basically comprises preparing a suitable ceramic composition and shaping it to give it a desired shape. Shaping can be specifically realised by casting, injection molding, pressing.

Preferably, a porous ceramic with a sintering temperature lower than 1100° C. is selected. The ceramic may be specifically selected among clays or silico-aluminous minerals, such as mullite or cordierite.

Generally, using this type of ceramic allows carrying out the sintering step (c) at a temperature lower than 1100° C. Thus, the structure and features of the interface layer, which undergoes the same thermal processing, are preserved at best.

The porosity of the ceramic may be obtained by adding pore-forming agents, especially polymeric particules which will be removed during thermal processing, or even by granular stacking of suitably sized grains.

Advantageously, a porous ceramic with a porosity between 30 and 70%, preferably between 40 and 60% is selected.

In case of a burner for fragrance diffuser, a too low porosity results in an too low impregnation of the catalytic support by the solvent containing the fragrance. On the opposite, a too high porosity results in a too low mechanical resistance of the material.

Advantageously, the suspension has the following features.

The suspension may contain between 15 wt % and 30 wt % of ceramic powder.

The ceramic powder preferably has a surface area higher than 5 m²/g, preferably between 5 m²/g and 30 m²/g.

In particular, the surface area may be measured by the Brunauer, Emett and Teller technique (BET method) commonly used in the art.

Using a high surface area interface layer allows to improve the dispersion of the catalyst at the surface of the support and therefore its efficiency. The catalyst is deposited in the form of small particules in the range of a few nanometers to increase the number of available active sites for catalyzing the desired reaction, e.g. the combustion reaction.

Thus, in case of a burner for fragrance diffuser, the presence of an interface layer at the surface of the base support avoids re-igniting a flame at too frequent intervals to restart the combustion.

In case of a catalytic reduction of pollutants such as those contained in exhaust gases, the presence of an interface layer allows to obtain a better efficiency for reducing pollutants.

Specifically, the ceramic powder is based on a material selected from the group consisting of spinel, alumina, perovskite, zirconia, apatite-type ceramics such as hydroxyapatite, titanium dioxyde and mixtures thereof.

Preferably, the at least one solvent is selected among water, organic solvents and mixtures thereof. Specifically, mixtures having a high water concentration will be used.

The suspension may contain a dispersing agent. It facilitates the dispersion of the ceramic powder in the solvent. Thus, the surface area of the ceramic powder in the suspension as well as its dispersion state are increased. In consequence, the interface layer forms a better adherence surface for the catalyst and enables an improved dispersion thereof.

The suspension contains preferably between 0.2 and 2 mg, more preferably between 0.5 and 1 mg, of dispersing agent per m² of ceramic powder based on the actual surface of the ceramic powder.

The actual surface of the ceramic powder is defined such as the surface area is the same as the actual surface per mass unit.

Advantageously, the dispersing agent is selected from the group consisting of 4,5-dihydroxy-1,3-benzenedisulfonic acid disodium salt, polyacrylates such as ammonium polyacrylate, polymethacrylates such as ammonium poymethacrylate and mixtures thereof. For instance, the ammonium polymethacrylate composition available from R.T. Vanderbilt Company under the name Darvan C will be used.

The suspension may also contain a binder. It allows increasing the viscosity of the suspension and its adherence to the support material. Thus, its deposition and mechanical properties at the surface of the base support are facilitated.

The suspension specifically contains between 1 and 10 wt %, preferably between 3 and 5 wt %, of binder based on the weight of the ceramic powder.

Advantageously, the binder is selected from the group consisting of acrylic polymers, methacrylic polymers, vinylic polymers, such as vinyl polyacetate, polyethylene oxides (PEO), cellulosic derivatives and mixtures thereof.

As exemplary acrylic polymer compositions suitable for use as a binder, compositions available from Dow Chemical under the name Duramax may be mentioned.

The above described properties of the suspension are particularly advantageous for carrying out the method of the invention. They allow achieving a better adherence of the interface layer on the non-sintered porous ceramic support. These properties are also useful for carrying out the firing of the interface layer while sintering the support without degrading the interface layer. Thus, the occurrence of microfractures in the interface layer is prevented. They are also useful for achieving a homogeneous structure suitable for a better dispersion of the catalyst at the surface of the interface layer.

Preferably, sintering is carried out at a temperature lower than 1100° C., specifically between 500 and 1000° C. The sintering temperature has to ensure both proper sintering of the porous ceramic and suitable firing of the interface layer, while preserving the structure and properties of both materials. A too high temperature damages the interface layer, particularly by the appearance of microfractures. A too low temperature is insufficient to carry out sintering of the support, i.e. to ensure a suitable cohesion of the ceramic.

Preferably, sintering is carried out at a heating rate between 1 and 5° C./min at a temperature step between 500 and 1100° C. for 1 hour.

The invention also relates to a method for manufacturing a catalyst support coated with its catalyst.

The method of the invention may, in this case, comprise, after step (c), a step (d) of depositing at least one catalyst on at least part of the interface layer, i.e. of the suspension deposited at the surface of the base support at step (b) and thermally treated with the base support at step (c).

Thus, a catalytic combustion support, coated with its catalyst and ready for use, is obtained.

The deposition of the catalyst can be achieved according to any conventionally employed method of the art, e.g. immersion deposition, spraying deposition of a catalyst composition at the surface of the interface layer, or spread coating, e.g. using a brush.

Specifically, the at least one catalyst is selected among platinum-based catalysts, palladium-based catalysts, rhodium-based catalysts or catalysts based on a mixture of these metals.

The at least one catalyst may, for example, be deposited in the form of a solution containing precursors of the desired metals. As precursors of these catalysts, platinum nitrate, rhodium nitrate, rhodium acetate, hydrated rhodium chloride, rhodium carbonyl complexes; palladium nitrate, palladium bromide, palladium chloride, palladium acetate, palladium sulphate; platinum chloride or platinum nitrate, may be used.

The invention also relates to a catalyst support. The support may be non coated or coated with its catalyst. When coated, it may specifically constitute a burner for fragrance diffuser manufactured according to the method as defined above.

Thus, a support with the desired shape corresponding to the intended use may be manufactured. In case of a fragrance diffuser burner, on can refer to the many examples contained in the art, e.g. to FR2779509, FR2856775 or FR2856776, which describe such burners in a detailed manner.

Using an interface layer at the surface of the support has the advantage of enabling a good dispersion of the catalyst, and therefore a good catalytic combustion.

Moreover, the manufacturing costs and the manufacturing time of such a support are reduced compared to the existing catalytic combustion supports.

### DETAILED DESCRIPTION OF THE INVENTION

The following example and appended FIGURE illustrate the present invention without limiting its scope.

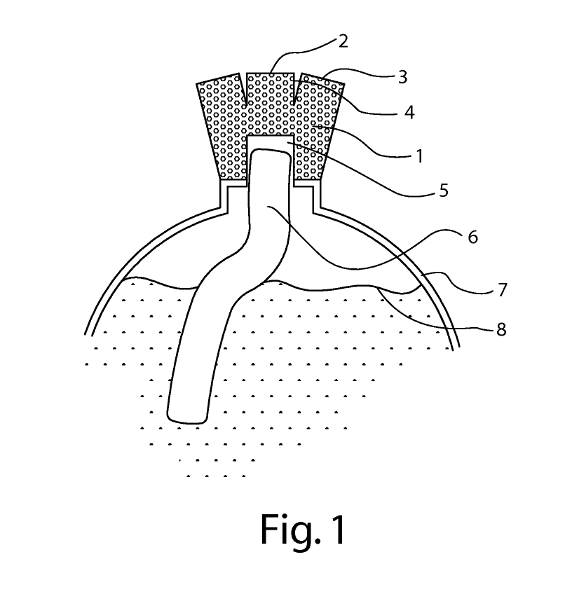

FIG. 1 represents a schematic cross sectional view of a burner for fragrance diffuser according to the invention, in use position on a flask.

Referring to FIG. 1, the burner 1 is in the form of a truncated cone and shows, in its upper part, a circular central area 2, also called diffusion area, and an annular peripheral area 3, also called combustion area. The peripheral area 3 is separated from the central area 2 by an annular groove 4. The burner 1 shows, in its lower part, a cylindrical cavity 5 open in the direction of a flask 7 when the burner is in the using position, i.e. arranged on a flask 7 partially filled with solvent 8. The cavity 5 is for receiving the end of a wick 6, whose other end dips in the solvent 8 contained in the flask 7, when the burner is in use.

### EXAMPLE

A burner for fragrance diffuser was manufactured according to the following method.

Firstly, a ceramic composition containing 75 wt % of a montmorionite-type fine clay and 25 wt % of crushed nut as a pore-forming agent. To this composition was added 3 wt % of a binder based on the weight of the clay, wherein the binder is a polyethylene glycol with a molecular weight of 20.000 g/mol.

Then, the ceramic was shaped by pressing, so as to obtain a non-sintered ceramic support having the shape of a burner for fragrance diffuser, as represented in a schematic cross sectional view in FIG. 1.

Then, an interface layer composition was prepared by dispersing 50 g of alumina powder in 172 mL of water with 0.5 g of Darvan C available from R.T. Vanderbilt Company as a dispersing agent and 5 g of Zusoplast available from Zschimmer and Schwarz. Then, this layer was deposited on the annular peripheral area of the ceramic support shaped as a burner. The deposition was achieved by dipping.

Then, the support coated with the interface layer was sintered at a temperature of 1000° C. for 1 h, and then allowed to cool down to room temperature.

Finally, by brush coating, on the peripheral area of the burner coated with the interface layer, a platinum nitrate solution containing 10.6 wt % of platinum, was deposited.

The resulting burner showed a finer and better distributed dispersion of the catalyst at the surface of the annular peripheral area 3 compared to a conventional burner having no interface layer, therefore resulting in a better catalytic combustion.

It is well understood that the example and embodiments that have been described above are illustratively given and are non-limiting and that modifications may be added without departing from the scope of the invention.

1 . A method for manufacturing a catalyst support, comprising, in the following order, the steps of:
(a) shaping a non-sintered porous ceramic base support;
(b) depositing, on at least part of the surface of the non-sintered porous ceramic base support, a suspension of ceramic powder in a solvent or a mixture of solvents to form an interface layer able to increase the surface area of the base support;
(c) sintering the base support, at least partially coated with the suspension,
wherein the method comprises only one firing step, during which both sintering of the porous ceramic base support and thermal processing of the suspension deposited at the surface of the base support are carried out.

2. A method according to claim 1, wherein a porous ceramic with a sintering temperature lower than 1100° C. is selected.

3. A method according to claim 1, wherein a porous ceramic with a porosity between 30 and 70% is selected.

4. A method according to claim 1, wherein the suspension further comprises between 15 wt % and 30 wt % of ceramic powder.

5. A method according to claim 1, wherein the ceramic powder has a surface area higher than 5 m²/g.

6. A method according to claim 1, wherein the ceramic powder is based on a material selected from the group consisting of spinel, alumina, perovskite, zirconia, apatite-type ceramics such as hydroxyapatite, titanium dioxide and mixtures thereof.

7. A method according to claim 1, wherein the at least one solvent is selected from the group consisting of water, organic solvents and mixtures thereof.

8. A method according to claim 1, wherein the suspension comprises a dispersing agent,

9. A method according to claim 8, wherein the suspension comprises between 0.2 and 2 mg of dispersing agent per m² of ceramic powder, based on the actual surface of the ceramic powder.

10. A method according to claim 8, wherein the dispersing agent is selected from the group consisting of 4,5-dihydroxy-1,3-benzenedisulfonic acid disodium salt, polyacrylates such as ammonium polyacrylate, polymethacrylates such as ammonium poymethacrylate and mixtures thereof.

11. A method according to claim 1, wherein the suspension comprises a binder.

12. A method according to claim 11, wherein the suspension comprises between 1 and 10 wt % of binder, based on the weight of the ceramic powder.

13. A method according to claim 11, characterized in that the binder is selected from the group consisting of acrylic polymers, methacrylic polymers, vinylic polymers, such as vinyl polyacetate, polyethylene oxides, cellulosic derivatives and mixtures thereof.

14. A method according to claim 1, wherein sintering is carried out at a temperature lower than 1100° C.

15. A method according to claim 1, wherein the method comprises, after step (c), a step (d) comprising depositing at least one catalyst on at least part of the interface layer.

16. A method according to claim 15, wherein the at least one catalyst is selected among platinum-based catalysts, palladium-based catalysts, rhodium-based catalysts or catalysts based on a mixture of these metals.
